(19) United States
(12) Patent Application Publication
(10) Pub. No.: US 2026/0018182 A1
(43) Pub. Date: Jan. 15, 2026

(54) ECHO CANCELLATION METHOD BASED ON DEEP LEARNING, DEVICE, AND READABLE STORAGE MEDIUM

(71) Applicant: AAC Acoustic Technologies (Shanghai) Co., Ltd., Shanghai (CN)

(72) Inventors: Guoteng Li, Shanghai (CN); Xuejing Sun, L.A., CA (US)

(21) Appl. No.: 19/001,392

(22) Filed: Dec. 24, 2024

Related U.S. Application Data
(63) Continuation of application No. PCT/CN2024/105520, filed on Jul. 15, 2024.

(51) Int. Cl. G10L 21/0208; H04M 9/08

(52) U.S. Cl. CPC G10L 21/0208; H04M 9/082; G10L 2021/02082

(57) ABSTRACT

The present application provides an echo cancellation method based on deep learning, a device, and a readable storage medium. A far-end microphone signal corresponding to a far-end room is obtained, and a near-end microphone signal corresponding to a near-end room is obtained; the far-end microphone signal is used as a reference signal, a first compressed complex number spectrum corresponding to the reference signal is obtained, and a second compressed complex number spectrum corresponding to the near-end microphone signal is obtained; the first compressed complex number spectrum and the second compressed complex number spectrum are input to a trained neural network model for echo cancellation, and a near-end speech compressed complex number spectrum is output; and inverse short-time Fourier transform is performed on the near-end speech compressed complex number spectrum to obtain a clear near-end speech signal.

### CROSS-REFERENCE TO RELATED APPLICATIONS

This application is a continuation of International Application No. PCT/CN2024/105520, filed on Jul. 15, 2024, the entire content of which is incorporated herein by reference.

### TECHNICAL FIELD

The present application relates to the technical field of artificial intelligence, and in particular, to the technical field of speech processing, which can be applied to an echo suppression scenario of a virtual spatial sound system. Specifically, the present application discloses an echo cancellation method based on deep learning, a device, and a readable storage medium.

### BACKGROUND

With the development of modern communication, virtual reality, and augmented reality technologies, users sometimes simultaneously communicate with different speakers in multiple rooms. Furthermore, to achieve a goal of “virtual reality”, in terms of audio design, information of speakers in different far-end rooms needs to be reconstructed to different directions of a near-end room, and virtual directions may also change correspondingly with movement of actual positions of the speakers at the far end, so as to satisfy a realistic auditory feeling of a listener. The realistic auditory feeling is an important factor in metaverse design. It combines a visual element, a tactile element, and other elements to provide users with a more realistic virtual environment. However, reverberation is inevitable in an actual acoustic environment, and there is usually an echo during communication between two parties, which affects an auditory experience of the users.

It is worth noting that the technologies described in this section may not necessarily be technologies that have been previously envisioned or used. Unless otherwise specified, it should not be assumed that any technology described in this section is considered to be an existing technology simply because it is included in this section. Similarly, unless otherwise specified, the issues mentioned in this section should not be considered to be universally acknowledged in any existing technology.

### SUMMARY

The present application provides an echo cancellation method based on deep learning, a device, and a readable storage medium, and aims to at least address one of the issues in the related technology to an extent.

To solve the above-mentioned problems, in the first aspect, the present application provides an echo cancellation method based on deep learning.

An echo cancellation method based on deep learning, includes: obtaining a far-end microphone signal corresponding to a far-end room, and obtaining a near-end microphone signal corresponding to a near-end room. Using the far-end microphone signal as a reference signal, obtaining a first compressed complex number spectrum corresponding to the reference signal, and obtaining a second compressed complex number spectrum corresponding to the near-end microphone signal. Inputting the first compressed complex number spectrum and the second compressed complex number spectrum to a trained neural network model for echo cancellation, and outputting a near-end speech compressed complex number spectrum. Performing inverse short-time Fourier transform on the near-end speech compressed complex number spectrum to obtain a clear near-end speech signal.

In the second aspect, the present application provides an echo cancellation apparatus based on deep learning, which includes a signal obtaining module, a complex number spectrum obtaining module, a model processing module and a signal transform module. The signal obtaining module configured to obtain a far-end microphone signal corresponding to a far-end room, and obtaining a near-end microphone signal corresponding to a near-end room. The complex number spectrum obtaining module configured to: use the far-end microphone signal as a reference signal, obtain a first compressed complex number spectrum corresponding to the reference signals, and obtain a second compressed complex number spectrum corresponding to the near-end microphone signal. The model processing module configured to: input the first compressed complex number spectrum and the second compressed complex number spectrum to a trained neural network model for echo cancellation, and output a near-end speech compressed complex number spectrum. The signal transform module configured to perform inverse short-time Fourier transform on the near-end speech compressed complex number spectrum to obtain a clear near-end speech signal.

In the third aspect, the present application provides an electronic device, which includes a memory and a processor. The processor is configured to run a computer program stored on the memory. The processor, when running the computer program, implements the steps in the echo cancellation method based on deep learning described in the first aspect.

In the fourth aspect, the present application provides a computer-readable storage medium, which has a computer program stored thereon. The computer program, when run by a processor, implements the steps in the echo cancellation method based on deep learning described in the first aspect.

As can be seen from the above, the present application provides an echo cancellation method based on deep learning, a device, and a readable storage medium. A far-end microphone signal corresponding to a far-end room is obtained, and a near-end microphone signal corresponding to a near-end room is obtained; the far-end microphone signal is used as a reference signal, a first compressed complex number spectrum corresponding to the reference signal is obtained, and a second compressed complex number spectrum corresponding to the near-end microphone signal is obtained; the first compressed complex number spectrum and the second compressed complex number spectrum are input to a trained neural network model for echo cancellation, and a near-end speech compressed complex number spectrum is output; and inverse short-time Fourier transform is performed on the near-end speech compressed complex number spectrum to obtain a clear near-end speech signal. By the implementation of the present application, the microphone signals of the far-end rooms are used as reference information of a neural network to recover the clear near-end speech signals, which can effectively suppress echo components, thus achieving echo suppression of a virtual spatial sound system.

It should be understood that the content described in this section is not intended to identify the key or important features of the present application, and is not intended to limit the scope of the present application. Other features of the present application will be easily understood through the following specification.

### BRIEF DESCRIPTION OF THE DRAWINGS

The accompanying drawings exemplarily show embodiments and form a part of this specification, and are combined with the textual description of this specification to explain exemplary implementations of the embodiments. The accompanying drawings shown are for illustrative purposes only and do not limit the scope of the claims. In all accompanying drawings, the same reference numerals represent similar but not necessarily identical elements.

FIG. 1 is a basic flow chart of an echo cancellation method based on deep learning according to an embodiment of the present application;

FIG. 2 is a schematic diagram of an echo cancellation application scenario based on a vector based amplitude panning (VBAP) technology according to an embodiment of the present application;

FIG. 3 is a schematic structural diagram of a neural network model according to an embodiment of the present application;

FIG. 4 is a representation diagram of test results corresponding to different loudspeaker layouts according to an embodiment of the present application;

FIG. 5 is a schematic diagram of an echo cancellation application scenario based on an Ambisonic technology according to an embodiment of the present application;

FIG. 6 is a representation diagram of test results obtained by processing recorded data using different algorithms in different loudspeaker layouts according to an embodiment of the present application;

FIG. 7 is a schematic diagram of functional modules of echo cancellation based on deep learning according to an embodiment of the present application; and

FIG. 8 is a schematic structural diagram of hardware of an electronic device according to an embodiment of the present application.

### DETAILED DESCRIPTION OF THE EMBODIMENTS

To make the aforementioned objectives, features, and advantages of the present invention more comprehensible, the accompanying drawings in the embodiment of the present invention are combined, The technical scheme in the embodiment of the present invention is clearly and completely described, Obviously, the described embodiment is only a part of the embodiment of the present invention, but not all embodiments are based on the embodiment of the present invention, and all other embodiments obtained by ordinary technicians in the field on the premise of not doing creative work belong to the protection range of the present invention.

In the description of the embodiments of the present application, the terms “first” and “second” are only used for descriptive purposes and cannot be understood as indicating or implying relative importance or implying the number of technical features indicated. Therefore, features defined by “first” and “second” may explicitly or implicitly include one or more of the features. The meaning of the term “plurality” is two or more, unless otherwise specifically limited. The term “include” indicates existence of the described features, wholes, steps, operations, elements, and/or components, but does not exclude existence or addition of one or more other features, wholes, steps, operations, elements, components, and/or sets thereof. The term “and/or” describes an association relationship of associated objects, indicating that there can be three types of relationships. For example, A and/or B can include situations where A exists alone, A and B exist simultaneously, or B exists alone. The character “/” generally indicates that front and after associated objects belong to an “or” relationship.

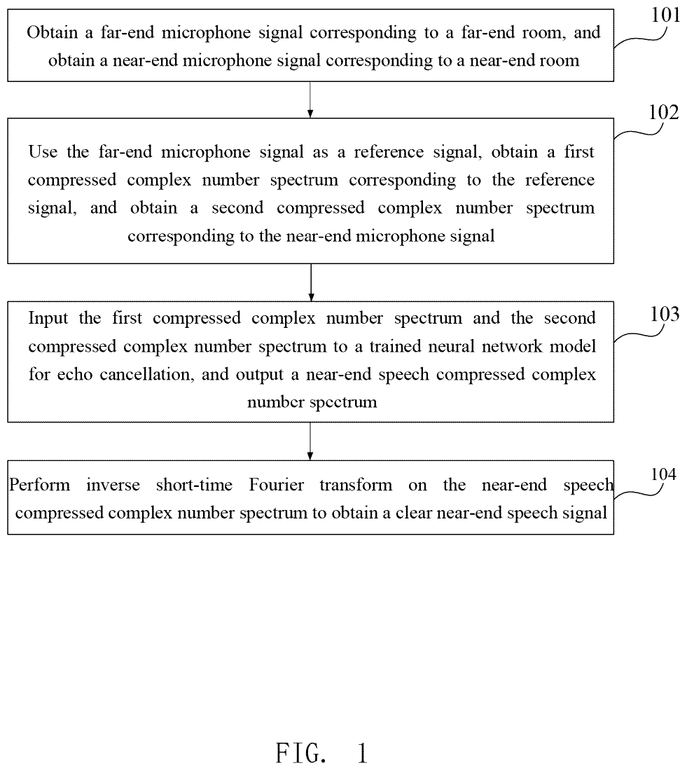

To address the problem of an echo in a virtual spatial sound system provided in the related technology. An embodiment of the present application provides an echo cancellation method based on deep learning. FIG. 1 is a basic flow chart of an echo cancellation method based on deep learning according to this embodiment. The echo cancellation method based on deep learning includes the following steps:

Step 101, a far-end microphone signal corresponding to a far-end room is obtained, and a near-end microphone signal corresponding to a near-end room is obtained.

Specifically, in a practical application scenario, a speech of a speaker in the far-end room needs to be reconstructed to different orientations in the near-end room. It is worth mentioning that a number of the far-end room may be K, and K can be greater than or equal to 1. The near-end room is provided with a loudspeaker array. The loudspeaker array can be arranged in a ring. In this embodiment, when the speaker in the far-end room speaks, the speech of the speaker can be reconstructed based on loudspeakers in the near-end room, and a plurality of virtual sound source positions can be set in the near-end room. Each virtual sound source position can be a position where a loudspeaker is located or a position between two adjacent loudspeakers. It should be noted that loudspeakers and microphones can be arranged in both the near-end room and the far-end room. Speech signals played by the loudspeakers are recorded by the microphones through an acoustic echo path.

A vector based amplitude panning (VBAP) technology is a virtual sound-image synthesis technology that requires fewer loudspeakers and has a more flexible loudspeaker layout when it is compared with a sound field synthesis method. In addition, the VBAP technology can be applied to different audio systems, such as stereo, surround sound, and spatial sound systems, and is also included in a moving picture experts group (MPEG)-H standard. In this embodiment, for the loudspeaker array on the circular ring, when the VBAP technology is used to replay a virtual sound source, two loudspeakers on two sides of the virtual sound source are usually selected. However, for a scenario where the position of the virtual sound source overlaps the position of a loudspeaker, the loudspeaker at the virtual sound source position is directly used for replaying.

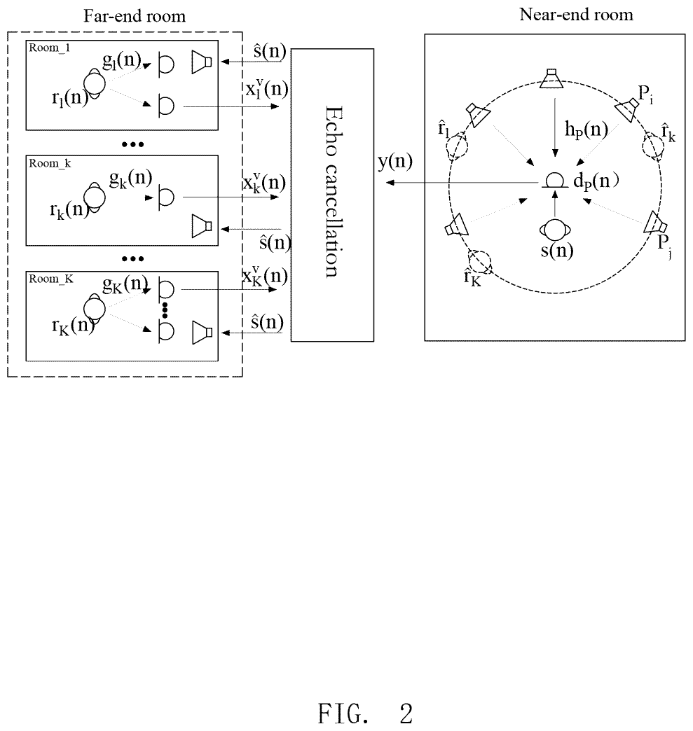

FIG. 2 is a schematic diagram of an echo cancellation application scenario based on a VBAP technology according to this embodiment. In the figure, rₖ(n) represents a speech signal of a speaker in a k^{th} far-end room; and \hat{r}ₖ represents a virtual sound source position. In some implementations of this embodiment, the above step that a near-end microphone signal corresponding to a near-end room is obtained includes: A near-end loudspeaker signal corresponding to a k^{th} loudspeaker of the near-end room is obtained; and the corresponding near-end microphone signal is obtained according to the near-end loudspeaker signal.

The near-end loudspeaker signal is represented as:

$${x}_{p} ( n ) = {\sum }_{k = 0}^{K} {δ}_{p , k} {x}_{k}^{v} ( n ) ;$$

where K represents a number of far-end rooms; δ_{p,k} represents a sound source signal gain, obtained using a VBAP algorithm, of a p^{th} loudspeaker for a k^{th} far-end room; and

$${x}_{k}^{v} ( n )$$

represents a far-end loudspeaker signal of a channel in the k^{th} far-end room.

The near-end microphone signal is represented as:

$$\begin{matrix}y ( n ) = {\sum }_{p = 0}^{P} {x}_{p} ( n ) * {h}_{p} ( n ) + s ( n ) + v ( n ) \\ = d ( n ) + s ( n ) + v ( n )\end{matrix} ;$$

where P represents a number of loudspeakers arrayed in the near-end room; hₚ(n) represents an echo path; s(n) represents a near-end speech signal; and v(n) represents additive noise.

Step 102, the far-end microphone signal is used as a reference signal; a first compressed complex number spectrum corresponding to the reference signal is obtained; and a second compressed complex number spectrum corresponding to the near-end microphone signal is obtained.

Specifically, in this embodiment, before the far-end microphone signal and the near-end microphone signal are input to a neural network model, short-time Fourier transform is first performed on the two signals, namely, the signals are transformed from a time domain to a frequency domain, thus respectively obtaining the compressed complex number spectrums corresponding to the two signals.

In some implementations of this embodiment, the above first compressed complex number spectrum is represented as:

$${X}_{k , R}^{c} = {\vert {X}_{k}^{v} \vert}^{β} \cdot cos ( θ ) , {X}_{k , l}^{c} = {\vert {X}_{k}^{v} \vert}^{β} \cdot sin ( θ ) ;$$

where

$$\{ {X}_{k , R}^{c} , {X}_{k , l}^{c} \}$$

represents the first compressed complex number spectrum;

$$\vert {X}_{k}^{v} \vert$$

and θ respectively represent amplitude information and phase information of the far-end microphone signal corresponding to a k^{th} far-end room; and β represents a preset constant. A preferable value of β may be ½.

Step 103, the first compressed complex number spectrum and the second compressed complex number spectrum are input to a trained neural network model for echo cancellation, and a near-end speech compressed complex number spectrum is output.

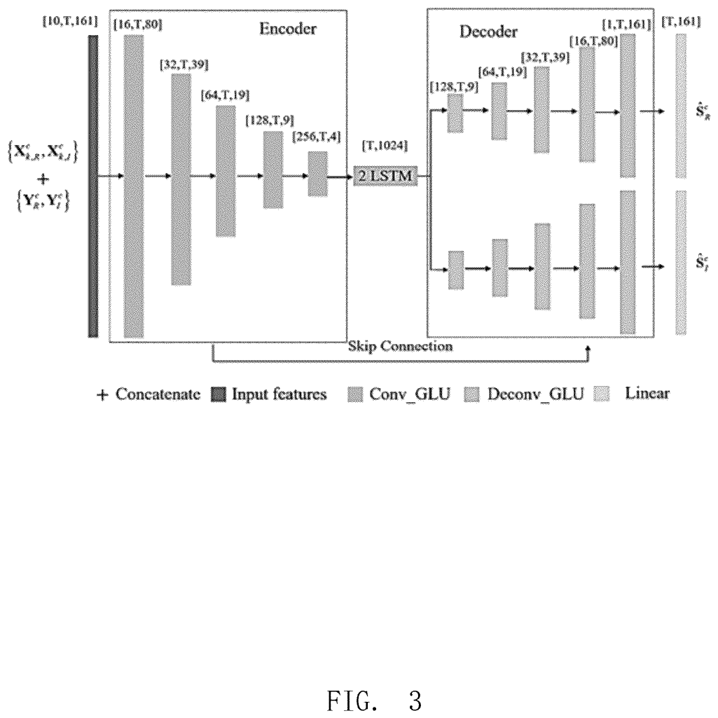

FIG. 3 is a schematic structural diagram of a neural network model according to this embodiment. Specifically, the neural network model of this embodiment includes: an encoder, a temporal modeling network, a decoder, and linear layers. The encoder is also in skip connection to the decoder. In a preferred implementation of this embodiment, the temporal modeling network includes two parallel Long Short-Term Memories (LSTMs).

A compressed complex number spectrum includes real part information and imaginary part information. In practical applications, this embodiment can perform a concatenating operation (Concatenate) on the first compressed complex number spectrum

$$\{ {X}_{k , R}^{c} , {X}_{k , l}^{c} \}$$

and the second compressed complex number spectrum

$$\{ {Y}_{R}^{c} , {Y}_{I}^{c} \}$$

and then use the first compressed complex number spectrum and the second compressed complex number spectrum as input features of the neural network model. Parameters of the input features are [10, T, 161]. The encoder of this embodiment may optionally include five cascaded gated convolutional layers (Conv_CLU). Parameters of the five gated convolutional layers are respectively [16, T, 80], [32, T, 39], [64, T, 19], [128, T, 9], and [256, T, 4]. Next, signal features extracted by the encoder are used as inputs of the temporal modeling network that includes the two parallel LSTMs. A signal temporal relationship is obtained through the temporal modeling network, and parameters of the LSTMs are [T, 1024]. Next, output features of the temporal modeling network are used as inputs including five gated deconvolutional layers (Deconv_GLU), and parameters of the five cascaded gated deconvolutional layers are [128], T, 9], [64, T, 19], [32, T, 39], [16, T, 80], and [1, T, 161]. Decoded features are processed through two parallel linear layers (Linear) to obtain an overall output of the neural network model, which is the near-end speech compressed complex number spectrum

$$\{ {\hat{S}}_{R}^{c} , {\hat{S}}_{I}^{c} \} .$$

Parameters of the linear layers are [T, 161].

In this embodiment, an initial neural network model is trained based on a preset training sample, and whether a training loss value satisfies a model convergence condition is determined based on a preset loss function. The loss function is used for measuring a difference between a predicted output in a training phase and a sample label. If the training loss value does not satisfy the model convergence condition, iterative training is continued after further adjusting the parameters of the neural network model until the model converges, thus obtaining the trained neural network model.

Continuing the foregoing neural network model of FIG. 3, the decoder includes two decoder branches. Each of the two decoder branches is connected to one linear layer. The loss function of the neural network model is represented as:

$$Loss = 0.5 \cdot [ {( \vert {S}_{R}^{c} \vert - {\vert {\hat{S}}_{R}^{c} \vert}^{2} + \vert {S}_{I}^{c} \vert - \vert {\hat{S}}_{I}^{c} \vert )}^{2} ] ;$$

where Loss represents a loss value;

$${\hat{S}}_{R}^{c} and {\hat{S}}_{I}^{c}$$

respectively represent a real part and an imaginary part of a predicted speech signal output by the neural network model; and

$${S}_{R}^{c} and {S}_{I}^{c}$$

respectively represent a real part and an imaginary part which are indicated by labels of a speech signal training sample.

Step 104, inverse short-time Fourier transform is performed on the near-end speech compressed complex number spectrum to obtain a clear near-end speech signal.

Finally, in this embodiment, the inverse short-time Fourier transform is performed on the near-end speech compressed complex number spectrum output by the model to reconstruct the clear near-end speech signal. The clear near-end speech signal effectively suppresses echo components.

To better demonstrate a result of the above echo cancellation scheme based on the VBAP technology and the deep learning technology according to the aforementioned embodiment of the present application, an embodiment of the present application further provides a comparative verification experiment for explanation, specifically as follows:

Assuming that the number of the far-end room in practical applications is 3, i.e. K=3, it also means that at most three speakers speak simultaneously in a plurality of far-end rooms during the same time period. Loudspeakers that achieve 5.1 surround sound are arranged in the near-end room. No subwoofer is used in the experiment, so P=5. The five loudspeakers used in the experiment have the same heights and are arranged on the same horizontal plane in a circular array, meaning that distances from the five loudspeakers to a center of the circle are consistent. In addition, a database used is a domain name system (DNS) database. A room impact response is generated using a mirror method. Experimental data covers situations where one, two, and three speakers speak simultaneously at the far end. In addition, the experiment further compares an echo denoising algorithm based on a Transformer model. Test indexes include Echo Return Loss Enhancement (ERLE) and Perceptual evaluation of speech quality (PESQ).

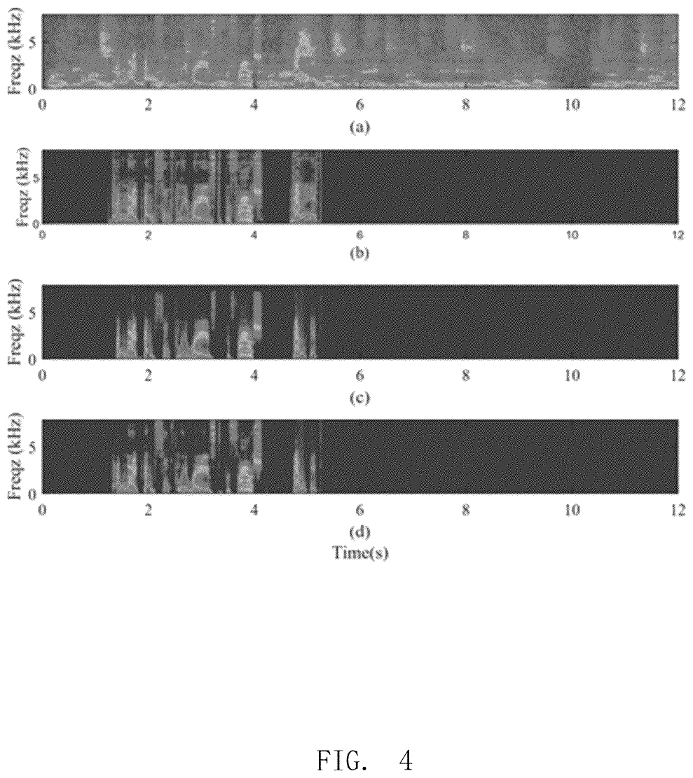

The model has good performance in a situation where five loudspeakers are arranged at the near end. To test the model in situations of different loudspeaker layouts in the near-end room, six loudspeakers are selected to be uniformly arranged on a circular ring, and a test condition of two speakers in the far-end room is selected. Namely, two virtual sound sources need to be replayed in the near-end room, and virtual sound source positions are set in a 45° direction and a 135° direction. For the layout of the six loudspeakers in the near-end room, test results of the model of this embodiment using the microphone signal as the reference and the Transformer model are given below. FIG. 4 is a representation diagram of test results corresponding to different loudspeaker layouts according to this embodiment. FIG. 4(a) is a speech spectrogram of a signal received by a microphone (PESQ=1.95). FIG. 4(b) is a speech spectrogram of a clear near-end speech signal. FIG. 4(c) is a speech spectrogram processed based on the Transformer model (ERLE=64.3 dB, PESQ=2.25). FIG. 4(d) is speech spectrogram processed based on the model of this embodiment (ERLE-63.5 dB, PESQ=2.54). Due to the layout of the six loudspeakers in the near-end room, according to the processing results in the figures, both the model of this embodiment and the Transformer model have good suppression effects on echo components, but the Transformer model has a more severe speech distortion. It is worth noting that in a case that a number of far-end speakers is fixed at K=3, the model imposes no limitation on the number of the loudspeakers in the near-end room, and can be applicable to any number of loudspeakers and loudspeaker layouts in any direction.

In some implementations of this embodiment, before the far-end microphone signal is used as a reference signal, the method further includes: A number of sound sources of all far-end rooms is obtained; and if the number of the sound sources is greater than or equal to a preset number threshold (e.g. 3), the far-end microphone signal is encoded into a B-format.

In different practical application scenarios, the numbers of the sound sources in the far-end room may vary. In an application scenario with a small number of sound sources in the far-end rooms, refer to the echo cancellation scheme based on the VBAP technology and the deep learning technology in the foregoing embodiment: using single-channel microphone signals (i.e. far-end microphone signals) of a plurality of far-end rooms as reference signals. For an application scenario with a large number of sound sources in the far-end rooms, this embodiment uses an echo cancellation scheme based on an Ambisonic technology and a deep learning technology. Unlike a traditional method that usually uses signals in a D-format as reference signals, this embodiment encodes microphone signals of a plurality of channels in the far-end rooms into the B-format (i.e. a first-order Ambisonic format). In this case, there is no upper limit on the number of the far-end rooms. Then, the signals in this format are used as the reference signals, and the compressed complex number spectrums are extracted and input to the neural network model to achieve the goal of echo cancellation.

It is worth mentioning that the Ambisonic technology is a classic method for replaying a spatial sound field. Based on a spherical harmonic analysis theory of plane waves, this technology uses a spherical harmonic function to encode and reconstruct a spatial sound field. Depending on different orders of the spherical harmonic function, the Ambisonic technology can replay spatial sound fields by using different numbers of loudspeakers in different layouts, and has high flexibility and expandability.

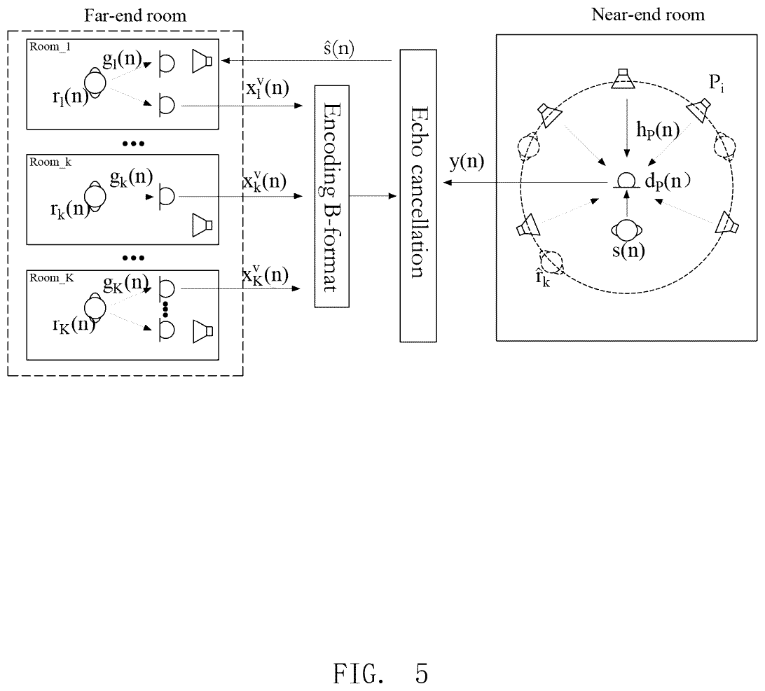

FIG. 5 is a schematic diagram of an echo cancellation application scenario based on an Ambisonic technology according to this embodiment. A difference from the schematic diagram of the echo cancellation application scenario based on the VBAP technology shown in FIG. 2 is only that far-end microphone signals need to be encoded into reference signals in a B-format. There are more channels for the reference signals in the B-format than ordinary reference signals. Other implementations of the two schemes can be kept being consistent.

To better demonstrate a result of the above echo cancellation scheme based on the Ambisonic technology and the deep learning technology according to the aforementioned embodiment of the present application, an embodiment of the present application further provides a comparative verification experiment for explanation, specifically as follows:

Assuming that there are four loudspeakers in the near-end room, the following three comparative experiments are carried out. Experiment I: The near-end room uses loudspeakers in a fixed layout. Namely, there is only one loudspeaker mode. This model is identified as D-format. Experiment II: The loudspeaker layout of the near-end room is not fixed. In the process of generating the near-end microphone signal, a decoding mode is generated according to an actual layout, but reference signals only use W channel of B-format signals. This model is identified as Singlechn. Experiment III: The loudspeaker layout of the near-end room is not fixed. In the process of generating the near-end microphone signal, a decoding mode is generated according to an actual layout. Reference signals only use B-format signals. This model is identified as B-format.

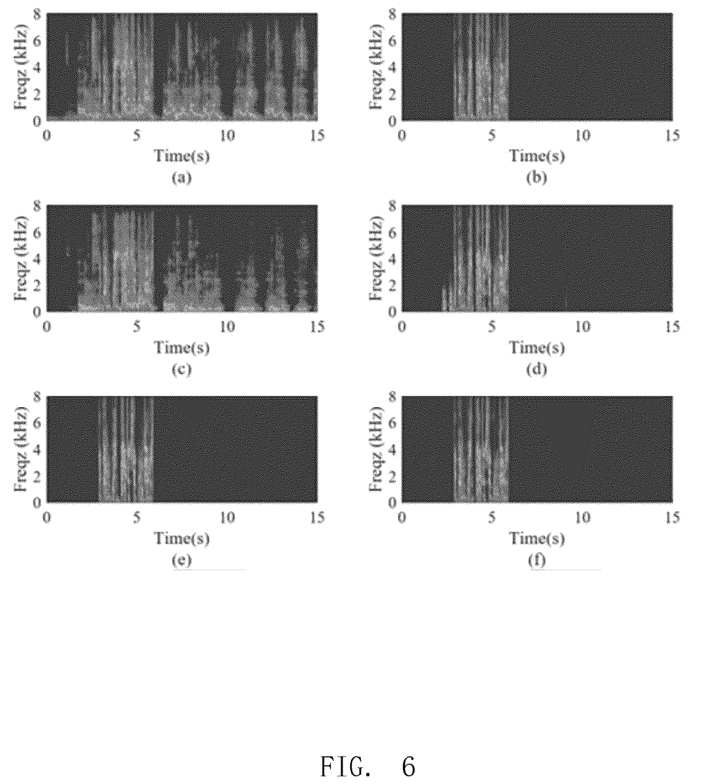

To test a generalization ability of the model for flexible loudspeaker layouts, loudspeaker layouts that do not appear in three model training sets are given, and experiments are carried out in a real room. In this experiment, there is only one far-end room, and four loudspeakers are arranged in the near-end room. FIG. 6 is a representation diagram of test results obtained by processing recorded data using different algorithms in different loudspeaker layouts according to this embodiment. FIG. 6(a) is a speech spectrogram of a signal received by a microphone (PESQ=2.45). FIG. 6(b) is a speech spectrogram of a clear near-end speech signal. FIG. 6(c) is a speech spectrogram based on a partitioned block frequency domain least mean square (PBFDLMS) algorithm (ERLE=14.1 dB, PESQ=2.59). FIG. 6(d) is a speech spectrogram based on a D-format model of this embodiment (ERLE=17.7 dB, PESQ=2.76). FIG. 6(e) is a speech spectrogram based on a Singlechn model (ERLE=52.6 dB, PESQ=2.85). FIG. 6(f) is a speech spectrogram based on a B-format model (ERLE=54.7 dB, PESQ=2.97).

From the above test results, it can be seen that if signals of loudspeakers in a single layout are used for reference, the generalization ability of the model for unknown loudspeaker layouts is insufficient. However, using one channel of the D-format model for reference can also achieve an echo suppression effect, but the performance of the D-format model is not as good as that of the B-format model, and the B-format model reflects a good generalization ability too.

In some implementations of this embodiment, the echo cancellation method further includes: Virtual sound source positions, respectively corresponding to a plurality of actual sound sources of the far-end room, in the near-end room are determined; a plurality of speech reconstruction instructions are correspondingly generated based on a plurality of clear near-end speech signals corresponding to the plurality of actual sound sources; and the speech reconstruction instructions are respectively transmitted to loudspeakers or loudspeaker combinations, corresponding to the virtual sound source positions, in the near-end room, to instruct the loudspeakers in different directions of the near-end room to play the corresponding clear near-end speech signals.

Specifically, in this embodiment, after the clear near-end speech signals are recovered, based on the neural network model, from the signals received by the microphones, the corresponding loudspeaker/loudspeaker combinations are determined according to the virtual sound source positions in the near-end room, and then the corresponding clear near-end speech signals are respectively transmitted to the loudspeakers in different directions, so that the speech signals of the plurality of speakers in the far-end room are reconstructed separately in the near-end room, and echo suppression of a virtual spatial sound system is also achieved. It is worth mentioning that the plurality of loudspeakers can be arranged in a ring shape in the near-end room. If a virtual sound source is located between two loudspeakers, the two loudspeakers on two sides of the virtual sound source are controlled to reconstruct a corresponding actual sound source. If a virtual sound source overlaps a single loudspeaker, the single loudspeaker at the virtual sound source position is controlled to reconstruct a corresponding actual sound source.

It should be understood that in this embodiment, serial numbers of the steps do not indicate an execution sequence of the steps, and the execution sequence of the steps should be determined according to functions and internal logics of the steps and should not impose a unique limitation on an implementation process of the embodiments of the present application.

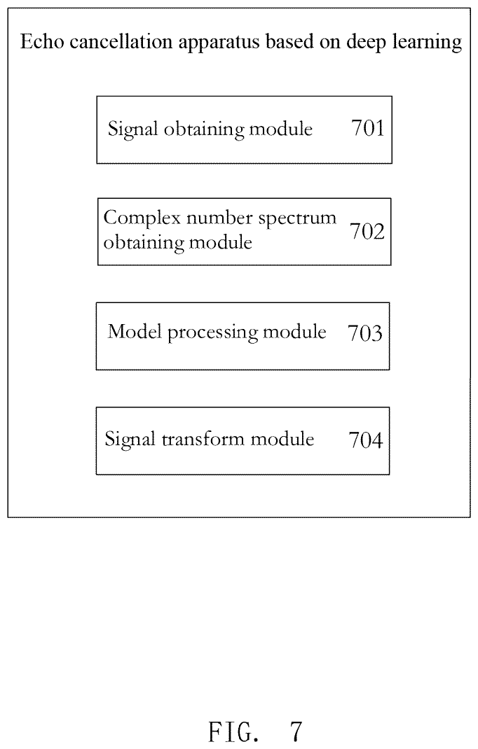

FIG. 7 is a schematic diagram of an echo cancellation apparatus based on deep learning according to an embodiment of the present application. The echo cancellation apparatus can be applied to the echo cancellation method in the aforementioned embodiment, and mainly includes:
a signal obtaining module 701, configured to obtain a far-end microphone signal corresponding to a far-end room, and obtaining a near-end microphone signal corresponding to a near-end room;
a complex number spectrum obtaining module 702, configured to: use the far-end microphone signal as a reference signal, obtain a first compressed complex number spectrum corresponding to the reference signals, and obtain a second compressed complex number spectrum corresponding to the near-end microphone signal;
a model processing module 703, configured to: input the first compressed complex number spectrum and the second compressed complex number spectrum to a trained neural network model for echo cancellation, and output a near-end speech compressed complex number spectrum; and
a signal transform module 704, configured to perform inverse short-time Fourier transform on the near-end speech compressed complex number spectrum to obtain a clear near-end speech signal.

In an optional implementation of this embodiment, the echo cancellation apparatus further includes: a signal encoding module, configured to: before using the far-end microphone signal as a reference signal, obtain a number of sound sources of all far-end rooms; and if the number of the sound sources is greater than or equal to a preset number threshold, encode the far-end microphone signal into a B-format.

In an optional implementation of this embodiment, the echo cancellation apparatus further includes: a speech reconstruction module, configured to: determine virtual sound source positions, respectively corresponding to a plurality of actual sound sources of the far-end room, in the near-end room; correspondingly generate a plurality of speech reconstruction instructions based on a plurality of clear near-end speech signals corresponding to the plurality of actual sound sources; and respectively transmit the speech reconstruction instructions to loudspeakers or loudspeaker combinations, corresponding to the virtual sound source positions, in the near-end room, to instruct the loudspeakers in different directions of the near-end room to play the corresponding clear near-end speech signals.

It should be noted that the echo cancellation methods in the foregoing method embodiments can be implemented based on the echo cancellation apparatus according to this embodiment. A person of ordinary skill in the art can clearly understand that for the convenience and conciseness of the description, for a specific working process of the echo cancellation apparatus described in this embodiment, refer to the corresponding working process in the foregoing method embodiments. It will not be elaborated here.

Based on the above technical solutions of the embodiments of the present application, a far-end microphone signal corresponding to a far-end room is obtained, and a near-end microphone signal corresponding to a near-end room is obtained; the far-end microphone signal is used as a reference signal, a first compressed complex number spectrum corresponding to the reference signal is obtained, and a second compressed complex number spectrum corresponding to the near-end microphone signal is obtained; the first compressed complex number spectrum and the second compressed complex number spectrum are input to a trained neural network model for echo cancellation, and a near-end speech compressed complex number spectrum is output; and inverse short-time Fourier transform is performed on the near-end speech compressed complex number spectrum to obtain a clear near-end speech signal. By the implementation of the present application, the microphone signals of the far-end rooms are used as reference information of a neural network to recover the clear near-end speech signals, which can effectively suppress echo components, thus achieving echo suppression of a virtual spatial sound system.

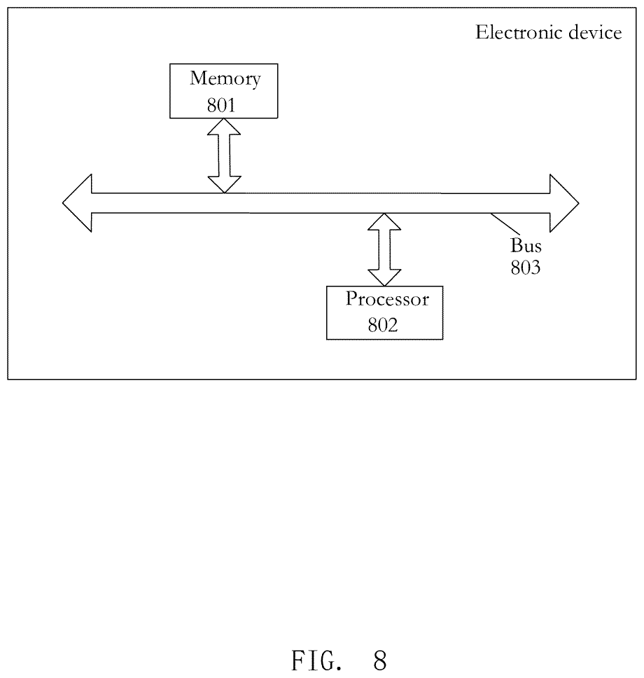

Referring to FIG. 8, FIG. 8 is an electronic device according to an embodiment of the preset application. The electronic device can be applied to implementing the echo cancellation method based on deep learning in the foregoing embodiment. As shown in FIG. 8, the electronic device mainly includes:
a memory 801, a processor 802, and a bus 803. The memory 801 and the processor 802 are connected through the bus 803. The memory 801 stores a computer program runnable on the processor 802. The processor 802, when running the computer program, implements the echo cancellation method based on deep learning in the foregoing embodiment. There may be one or more processors.

The memory 801 may be a high-speed Random Access Memory (RAM), or may be a non-volatile memory, for example, a magnetic disk memory. The memory 801 is configured to store executable program codes. The processor 802 is coupled with the memory 801.

Further, the embodiments of the present application further provides a computer-readable storage medium. The computer-readable storage medium may be set in the electronic device in the above embodiments or may be the memory in the foregoing embodiment shown in FIG. 8.

The computer-readable storage medium has a computer program stored thereon. The program, when run by a processor, implements the echo cancellation method based on deep learning in the foregoing embodiments. Further, the computer-readable storage medium may be: various media that can store program codes, such as a USB flash drive, a mobile hard disk drive, a Read-Only Memory (ROM), a RAM, a magnetic disk, and a compact disc.

In the several embodiments provided in the present application, it should be understood that the disclosed apparatus and method are achieved in other manners. For example, the above-described apparatus embodiment is merely illustrative. For example, the division of the modules is only one type of logical functional division, and other divisions is achieved in practice. For example, multiple modules or components can be combined or integrated into another system, or some features can be omitted, or not executed. In addition, the shown or discussed mutual coupling or direct coupling or communication connection is an indirect coupling or communication connection through some interfaces, apparatuses or modules, and is in an electrical, mechanical or another form.

The modules described as separate parts may or may not be physically separate, and parts displayed as modules may or may not be physical modules, may be located in one position, or may be distributed on a plurality of network modules. Some or all of the modules are selected according to actual needs to achieve the objective of the solution of this embodiment.

In addition, functional modules in embodiments of the present application may be integrated into one processing module, or each of the modules may exist alone physically, or two or more modules are integrated into one module. The integrated modules mentioned above can be implemented in both a hardware form and a software functional module form.

When the integrated module is implemented in the form of a software functional module and sold or used as an independent product, the integrated module may be stored in a computer-readable storage medium. Based on such an understanding, the technical solutions of the present application essentially, or the part contributing to the existing technology, or all or some of the technical solutions may be implemented in the form of a software product. The computer software product is stored in a readable storage medium and includes several instructions for instructing a computer device (which may be a personal computer, a server, a network device, or the like) to execute all or some of the steps of the methods described in the embodiments of the present application. The aforementioned readable storage media include: various media that can store program codes, such as a USB flash disk, a mobile hard disk drive, a ROM, a RAM, a magnetic disk, and a compact disc.

It should be noted that for the aforementioned method embodiments, for the sake of simplicity, they are all described as a series of action combinations. However, those skilled in the art should be aware that the present application is not limited by the order of the described actions, as according to the present application, certain steps can be performed in other orders or simultaneously. Secondly, those skilled in the art should also be aware that the embodiments described in this specification are all preferred embodiments, and the actions and modules involved may not be necessary for the present application.

In the foregoing embodiments, the description of each embodiment has respective focuses. For a part that is not described in detail in an embodiment, reference may be made to related descriptions in other embodiments.

The above content describes the echo cancellation method and device based on deep learning and the readable storage medium according to the present application, a person skilled in the art can make changes to specific implementations and the application scope according to the ideas of the embodiments of the present application. In summary, the content of this specification should not be understood as a limitation on the present application.

What is claimed is:

1. An echo cancellation method based on deep learning, comprising:
obtaining a far-end microphone signal corresponding to a far-end room, and obtaining a near-end microphone signal corresponding to a near-end room;
using the far-end microphone signal as a reference signal, obtaining a first compressed complex number spectrum corresponding to the reference signal, and obtaining a second compressed complex number spectrum corresponding to the near-end microphone signal;
inputting the first compressed complex number spectrum and the second compressed complex number spectrum to a trained neural network model for echo cancellation, and outputting a near-end speech compressed complex number spectrum; and
performing inverse short-time Fourier transform on the near-end speech compressed complex number spectrum to obtain a clear near-end speech signal.

2. The echo cancellation method according to claim 1, before the using the far-end microphone signal as a reference signal, further comprising:
obtaining a number of sound sources of all far-end rooms; and
if the number of the sound sources is greater than or equal to a preset number threshold, encoding the far-end microphone signal into a B-format.

3. The echo cancellation method according to claim 1, wherein the obtaining a near-end microphone signal corresponding to a near-end room comprises:
obtaining a near-end loudspeaker signal corresponding to a k^{th} loudspeaker of the near-end room, wherein the near-end loudspeaker signal is represented as:
$${x}_{p} ( n ) = {\sum }_{k = 0}^{K} {δ}_{p , k} {{x}_{k}^{v} ( n )}_{;}$$
wherein K represents a number of the far-end room; δ_{p,k} represents a sound source signal gain of a p^{th} loudspeaker for a k^{th} far-end room;
$${x}_{k}^{v} ( n )$$
represents a far-end loudspeaker signal of a channel in the k^{th} far-end room; and
obtaining the corresponding near-end microphone signal according to the near-end loudspeaker signal, wherein the near-end microphone signal is represented as:
$$\begin{matrix}y ( n ) = {\sum }_{p = 0}^{P} {x}_{p} ( n ) * {h}_{p} ( n ) + s ( n ) + v ( n ) \\ = d ( n ) + s ( n ) + v ( n ) ;\end{matrix}$$
wherein P represents a number of loudspeakers arrayed in the near-end room; hₚ(n) represents an echo path; s(n) represents a near-end speech signal; and v(n) represents additive noise.

4. The echo cancellation method according to claim 1, wherein the first compressed complex number spectrum is represented as:
$${X}_{k , R}^{c} = {\vert {X}_{k}^{v} \vert}^{β} \cdot cos ( θ ) , {X}_{k , I}^{c} = {\vert {X}_{k}^{v} \vert}^{β} \cdot sin ( θ ) ;$$
wherein
$$\{ {X}_{k , R}^{c} , {X}_{k , I}^{c} \}$$
represents the first compressed complex number spectrum;
$$\vert {X}_{k}^{v} \vert$$
and θ respectively represent amplitude information and phase information of the far-end microphone signal corresponding to a k^{th} far-end room; and β represents a preset constant.

5. The echo cancellation method according to claim 1, wherein the neural network model comprises: an encoder, a temporal modeling network, a decoder, and linear layers which are connected in sequence; and the encoder is further in skip connection to the decoder.

6. The echo cancellation method according to claim 5, wherein the decoder comprises two decoder branches; each of the two decoder branches is connected to one linear layer; a loss function of the neural network model is represented as:
$$Loss = 0.5 \cdot [ {( \vert {S}_{R}^{c} \vert - \vert {{\hat{S}}_{R}^{c}}^{} \vert )}^{2} + {( \vert {S}_{I}^{c} \vert - \vert {\hat{S}}_{I}^{c} \vert )}^{2} ] ;$$
wherein Loss represents a loss value;
$${\hat{S}}_{R}^{c} and {\hat{S}}_{I}^{c}$$
respectively represent a real part and an imaginary part of a predicted speech signal output by the neural network model; and
$${S}_{R}^{c} and {S}_{I}^{c}$$
respectively represent a real part and an imaginary part which are indicated by labels of a speech signal training sample.

7. The echo cancellation method according to claim 1, further comprising:
determining virtual sound source positions, respectively corresponding to a plurality of actual sound sources of the far-end room, in the near-end room;
correspondingly generating a plurality of speech reconstruction instructions based on a plurality of clear near-end speech signals corresponding to the plurality of actual sound sources; and
respectively transmitting the speech reconstruction instructions to loudspeakers or loudspeaker combinations, corresponding to the virtual sound source positions, in the near-end room, to instruct the loudspeakers in different directions of the near-end room to play the corresponding clear near-end speech signals.

8. An echo cancellation apparatus based on deep learning, comprising:
a signal obtaining module, configured to obtain a far-end microphone signal corresponding to a far-end room, and obtaining a near-end microphone signal corresponding to a near-end room;
a complex number spectrum obtaining module, configured to: use the far-end microphone signal as a reference signal, obtain a first compressed complex number spectrum corresponding to the reference signals, and obtain a second compressed complex number spectrum corresponding to the near-end microphone signal;
a model processing module, configured to: input the first compressed complex number spectrum and the second compressed complex number spectrum to a trained neural network model for echo cancellation, and output a near-end speech compressed complex number spectrum; and
a signal transform module, configured to perform inverse short-time Fourier transform on the near-end speech compressed complex number spectrum to obtain a clear near-end speech signal.

9. An electronic device, comprising: a memory and a processor,
wherein the processor is configured to run a computer program stored on the memory; and
the processor, when running the computer program, implements the steps in the echo cancellation method based on deep learning according to claim 1.

10. A computer-readable storage medium, having a computer program stored thereon, wherein the computer program, when run by a processor, implements the steps in the echo cancellation method based on deep learning according to claim 1.
